(19) United States
(12) Patent Application Publication
(10) Pub. No.: US 2017/0265135 A1
(43) Pub. Date: Sep. 14, 2017

(54) STATION (STA), ACCESS POINT (AP) AND METHOD FOR COMMUNICATION OF CONTROL INFORMATION FOR UPLINK TRANSMISSION

(71) Applicants: Laurent Cariou, Portland, OR (US); Robert J. Stacey, Portland, OR (US); Daniel F. Bravo, Hillsboro, OR (US)

(72) Inventors: Laurent Cariou, Portland, OR (US); Robert J. Stacey, Portland, OR (US); Daniel F. Bravo, Hillsboro, OR (US)

(21) Appl. No.: 15/192,337

(22) Filed: Jun. 24, 2016

Related U.S. Application Data
(60) Provisional application No. 62/305,764, filed on Mar. 9, 2016.

(51) Int. Cl. H04W 52/02; H04W 72/04; H04B 7/04; H04W 72/00; H04L 5/00

(52) U.S. Cl. CPC H04W 52/0219; H04W 72/005; H04L 5/0023; H04B 7/0452; H04W 72/0413; H04W 72/048; H04W 84/12

(57) ABSTRACT

Embodiments of an access point (AP), station (STA) and method for communication of control information for uplink transmission are generally described herein. The AP may transmit a trigger frame (TF) that indicates a resource unit (RU) to be used by an STA for an uplink data transmission. The AP may transmit a downlink data packet that indicates an RU to be used by the STA for a transmission of an acknowledgement message. In these and other cases, an RU allocation index may be used to indicate the RU. In addition, a group of one or more spatial streams (SSs) to be used by the STA for the uplink data transmission may be included in the TF.

### PRIORITY CLAIM

This application claims priority under 35 USC 119(e) to U.S. Provisional Patent Application Ser. No. 62/305,764, filed Mar. 9, 2016 [reference number P96932Z (4884.491PRV)] which is incorporated herein by reference in its entirety.

### TECHNICAL FIELD

Embodiments pertain to wireless networks. Some embodiments relate to wireless local area networks (WLANs) and Wi-Fi networks including networks operating in accordance with the IEEE 802.11 family of standards, such as the IEEE 802.11ac standard or the IEEE 802.11ax study group (SG) (named DensiFi). Some embodiments relate to high-efficiency (HE) wireless or high-efficiency WLAN or Wi-Fi (HEW) communications. Some embodiments relate to trigger frames (TFs). Some embodiments relate to downlink HE data transmission and acknowledgement.

### BACKGROUND

Wireless communications has been evolving toward ever increasing data rates (e.g., from IEEE 802.11a/g to IEEE 802.11n to IEEE 802.11ac). In high-density deployment situations, overall system efficiency may become more important than higher data rates. For example, in high-density hotspot and cellular offloading scenarios, many devices competing for the wireless medium may have low to moderate data rate requirements (with respect to the very high data rates of IEEE 802.11ac). A recently-formed study group for Wi-Fi evolution referred to as the IEEE 802.11 High Efficiency WLAN (HEW) study group (SG) (i.e., IEEE 802.11ax) is addressing these high-density deployment scenarios.

### BRIEF DESCRIPTION OF THE DRAWINGS

FIG. 1 illustrates a wireless network in accordance with some embodiments;

FIG. 2 illustrates an example machine in accordance with some embodiments;

FIG. 3 illustrates a station (STA) in accordance with some embodiments and an access point (AP) in accordance with some embodiments;

FIG. 4 illustrates the operation of a method of communication in accordance with some embodiments;

FIG. 5 illustrates example frames and packets that may be exchanged in accordance with some embodiments;

FIG. 6 illustrates example control fields in accordance with some embodiments;

FIG. 7 illustrates additional example frames and packets that may be exchanged in accordance with some embodiments;

FIG. 8 illustrates additional example control fields in accordance with some embodiments;

FIG. 9 illustrates an example assignment of indexes in accordance with some embodiments;

FIG. 10 illustrates another example assignment of indexes in accordance with some embodiments;

FIG. 11 illustrates another example assignment of indexes in accordance with some embodiments;

FIG. 12 illustrates an example allocation block in accordance with some embodiments; and

FIG. 13 illustrates the operation of another method of communication in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

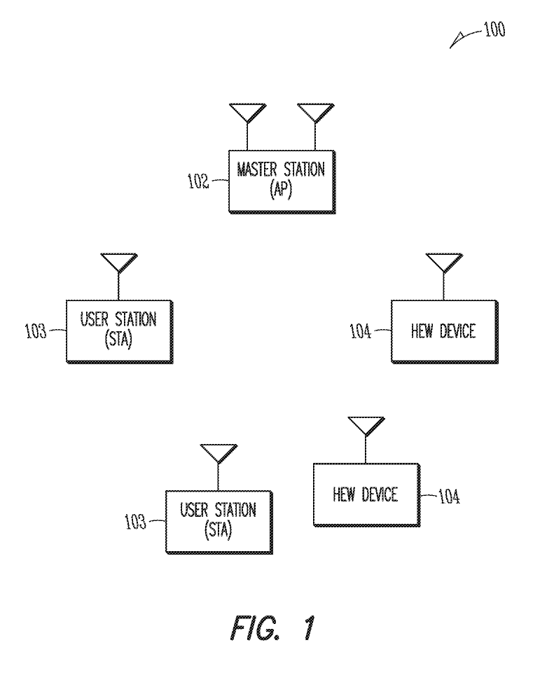

FIG. 1 illustrates a wireless network in accordance with some embodiments. In some embodiments, the network 100 may be a High Efficiency Wireless (HEW) Local Area Network (LAN) network. In some embodiments, the network 100 may be a Wireless Local Area Network (WLAN) or a Wi-Fi network. These embodiments are not limiting, however, as some embodiments of the network 100 may include a combination of such networks. That is, the network 100 may support HEW devices in some cases, non HEW devices in some cases, and a combination of HEW devices and non HEW devices in some cases. Accordingly, it is understood that although techniques described herein may refer to either a non HEW device or to an HEW device, such techniques may be applicable to both non HEW devices and HEW devices in some cases.

Referring to FIG. 1, the network 100 may include any or all of the components shown, and embodiments are not limited to the number of each component shown in FIG. 1. In some embodiments, the network 100 may include a master station (AP) 102 and may include any number (including zero) of stations (STAs) 103 and/or HEW devices 104. In some embodiments, the AP 102 may transmit a trigger frame (TF) to an STA 103 to indicate that the STA 103 is to perform an uplink data transmission to the AP. In some embodiments, the AP 102 may transmit downlink data packets to the STA 103, and the STA 103 may transmit a block acknowledgement (BA) message for the downlink data packets. These embodiments will be described in more detail below.

The AP 102 may be arranged to communicate with one or more of the components shown in FIG. 1 in accordance with one or more IEEE 802.11 standards (including 802.11ax and/or others), other standards and/or other communication protocols. It should be noted that embodiments are not limited to usage of an AP 102. References herein to the AP 102 are not limiting and references herein to the master station 102 are also not limiting. In some embodiments, a STA 103, HEW device 104 and/or other device may be configurable to operate as a master station. Accordingly, in such embodiments, operations that may be performed by the AP 102 as described herein may be performed by the STA 103, HEW device 104 and/or other device that is configurable to operate as the master station.

In some embodiments, one or more of the STAs 103 may be legacy stations. These embodiments are not limiting, however, as the STAs 103 may be configured to operate as HEW devices 104 or may support HEW operation in some embodiments. The master station 102 may be arranged to communicate with the STAs 103 and/or the HEW stations 104 in accordance with one or more of the IEEE 802.11 standards, including 802.11ax and/or others. In accordance with some HEW embodiments, an access point (AP) may operate as the master station 102 and may be arranged to contend for a wireless medium (e.g., during a contention period) to receive exclusive control of the medium for an HEW control period (i.e., a transmission opportunity (TXOP)). The master station 102 may, for example, transmit a master-sync or control transmission at the beginning of the HEW control period to indicate, among other things, which HEW stations 104 are scheduled for communication during the HEW control period. During the HEW control period, the scheduled HEW stations 104 may communicate with the master station 102 in accordance with a non-contention based multiple access technique. This is unlike conventional Wi-Fi communications in which devices communicate in accordance with a contention-based communication technique, rather than a non-contention based multiple access technique. During the HEW control period, the master station 102 may communicate with HEW stations 104 using one or more HEW frames. During the HEW control period, STAs 103 not operating as HEW devices may refrain from communicating in some cases. In some embodiments, the master-sync transmission may be referred to as a control and schedule transmission.

In some embodiments, the multiple-access technique used during the HEW control period may be a scheduled orthogonal frequency division multiple access (OFDMA) technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique including a multi-user (MU) multiple-input multiple-output (MIMO) (MU-MIMO) technique. These multiple-access techniques used during the HEW control period may be configured for uplink or downlink data communications.

The master station 102 may also communicate with STAs 103 and/or other legacy stations in accordance with legacy IEEE 802.11 communication techniques. In some embodiments, the master station 102 may also be configurable to communicate with the HEW stations 104 outside the HEW control period in accordance with legacy IEEE 802.11 communication techniques, although this is not a requirement.

In some embodiments, the HEW communications during the control period may be configurable to use one of 20 MHz, 40 MHz, or 80 MHz contiguous bandwidths or an 80+80 MHz (160 MHz) non-contiguous bandwidth. In some embodiments, a 320 MHz channel width may be used. In some embodiments, sub-channel bandwidths less than 20 MHz may also be used. In these embodiments, each channel or sub-channel of an HEW communication may be configured for transmitting a number of spatial streams.

In some embodiments, high-efficiency wireless (HEW) techniques may be used, although the scope of embodiments is not limited in this respect. As an example, techniques included in 802.11ax standards and/or other standards may be used. In accordance with some embodiments, a master station 102 and/or HEW stations 104 may generate an HEW packet in accordance with a short preamble format or a long preamble format. The HEW packet may comprise a legacy signal field (L-SIG) followed by one or more high-efficiency (HE) signal fields (HE-SIG) and an HE long-training field (HE-LTF). For the short preamble format, the fields may be configured for shorter-delay spread channels. For the long preamble format, the fields may be configured for longer-delay spread channels. These embodiments are described in more detail below. It should be noted that the terms “HEW” and “HE” may be used interchangeably and both terms may refer to high-efficiency Wireless Local Area Network operation and/or high-efficiency Wi-Fi operation.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

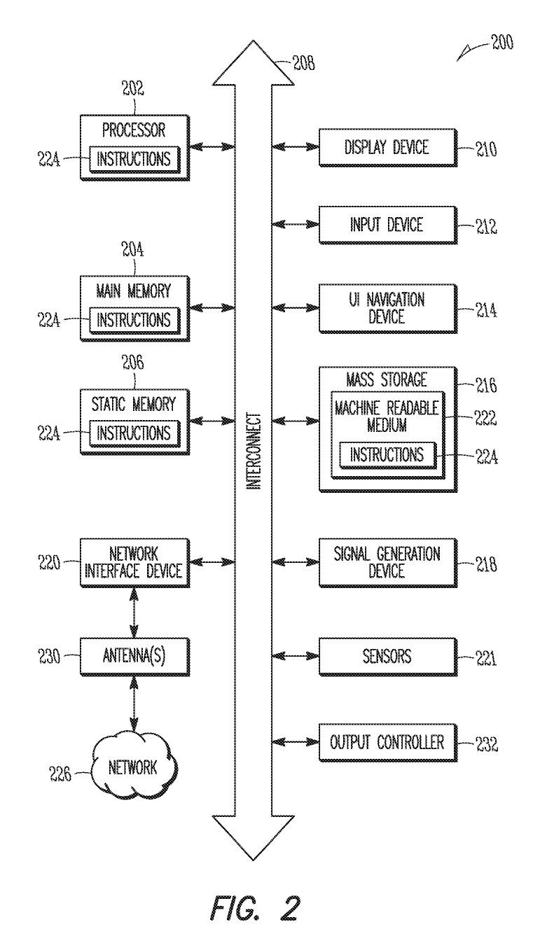

FIG. 2 illustrates a block diagram of an example machine in accordance with some embodiments. The machine 200 is an example machine upon which any one or more of the techniques and/or methodologies discussed herein may be performed. In alternative embodiments, the machine 200 may operate as a standalone device or may be connected (e.g., networked) to other machines. In a networked deployment, the machine 200 may operate in the capacity of a server machine, a client machine, or both in server-client network environments. In an example, the machine 200 may act as a peer machine in peer-to-peer (P2P) (or other distributed) network environment. The machine 200 may be an AP 102, STA 103, HEW device, HEW AP, HEW STA, UE, eNB, mobile device, base station, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The machine (e.g., computer system) 200 may include a hardware processor 202 (e.g., a central processing unit (CPU), a graphics processing unit (GPU), a hardware processor core, or any combination thereof), a main memory 204 and a static memory 206, some or all of which may communicate with each other via an interlink (e.g., bus) 208. The machine 200 may further include a display unit 210, an alphanumeric input device 212 (e.g., a keyboard), and a user interface (UI) navigation device 214 (e.g., a mouse). In an example, the display unit 210, input device 212 and UI navigation device 214 may be a touch screen display. The machine 200 may additionally include a storage device (e.g., drive unit) 216, a signal generation device 218 (e.g., a speaker), a network interface device 220, and one or more sensors 221, such as a global positioning system (GPS) sensor, compass, accelerometer, or other sensor. The machine 200 may include an output controller 228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a machine readable medium 222 on which is stored one or more sets of data structures or instructions 224 (e.g., software) embodying or utilized by any one or more of the techniques or functions described herein. The instructions 224 may also reside, completely or at least partially, within the main memory 204, within static memory 206, or within the hardware processor 202 during execution thereof by the machine 200. In an example, one or any combination of the hardware processor 202, the main memory 204, the static memory 206, or the storage device 216 may constitute machine readable media. In some embodiments, the machine readable medium may be or may include a non-transitory computer-readable storage medium. In some embodiments, the machine readable medium may be or may include a computer-readable storage medium.

While the machine readable medium 222 is illustrated as a single medium, the term “machine readable medium” may include a single medium or multiple media (e.g., a centralized or distributed database, and/or associated caches and servers) configured to store the one or more instructions 224. The term “machine readable medium” may include any medium that is capable of storing, encoding, or carrying instructions for execution by the machine 200 and that cause the machine 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 224 may further be transmitted or received over a communications network 226 using a transmission medium via the network interface device 220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 220 may include one or more physical jacks (e.g., Ethernet, coaxial, or phone jacks) or one or more antennas to connect to the communications network 226. In an example, the network interface device 220 may include a plurality of antennas to wirelessly communicate using at least one of single-input multiple-output (SIMO), multiple-input multiple-output (MIMO), or multiple-input single-output (MISO) techniques. In some examples, the network interface device 220 may wirelessly communicate using Multiple User MIMO techniques. The term “transmission medium” shall be taken to include any intangible medium that is capable of storing, encoding or carrying instructions for execution by the machine 200, and includes digital or analog communications signals or other intangible medium to facilitate communication of such software.

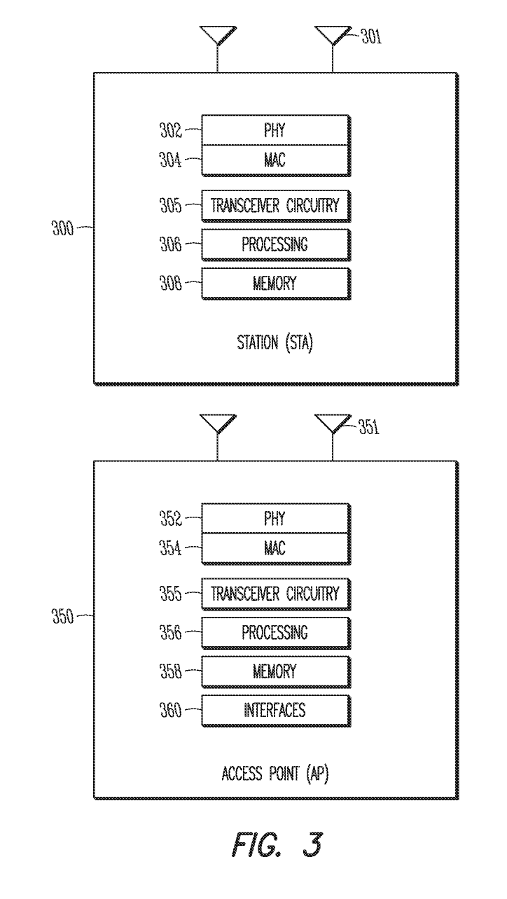

FIG. 3 illustrates a station (STA) in accordance with some embodiments and an access point (AP) in accordance with some embodiments. It should be noted that in some embodiments, an STA or other mobile device may include some or all of the components shown in either FIG. 2 or FIG. 3 (as in 300) or both. The STA 300 may be suitable for use as an STA 103 as depicted in FIG. 1, in some embodiments. It should also be noted that in some embodiments, an AP or other base station may include some or all of the components shown in either FIG. 2 or FIG. 3 (as in 350) or both. The AP 350 may be suitable for use as an AP 102 as depicted in FIG. 1, in some embodiments.

The STA 300 may include physical layer circuitry 302 and a transceiver 305, one or both of which may enable transmission and reception of signals to and from components such as the AP 102 (FIG. 1), other STAs or other devices using one or more antennas 301. As an example, the physical layer circuitry 302 may perform various encoding and decoding functions that may include formation of baseband signals for transmission and decoding of received signals. As another example, the transceiver 305 may perform various transmission and reception functions such as conversion of signals between a baseband range and a Radio Frequency (RF) range. Accordingly, the physical layer circuitry 302 and the transceiver 305 may be separate components or may be part of a combined component. In addition, some of the described functionality related to transmission and reception of signals may be performed by a combination that may include one, any or all of the physical layer circuitry 302, the transceiver 305, and other components or layers. The STA 300 may also include medium access control layer (MAC) circuitry 304 for controlling access to the wireless medium. The STA 300 may also include processing circuitry 306 and memory 308 arranged to perform the operations described herein.

The AP 350 may include physical layer circuitry 352 and a transceiver 355, one or both of which may enable transmission and reception of signals to and from components such as the STA 103 (FIG. 1), other APs or other devices using one or more antennas 351. As an example, the physical layer circuitry 352 may perform various encoding and decoding functions that may include formation of baseband signals for transmission and decoding of received signals. As another example, the transceiver 355 may perform various transmission and reception functions such as conversion of signals between a baseband range and a Radio Frequency (RF) range. Accordingly, the physical layer circuitry 352 and the transceiver 355 may be separate components or may be part of a combined component. In addition, some of the described functionality related to transmission and reception of signals may be performed by a combination that may include one, any or all of the physical layer circuitry 352, the transceiver 355, and other components or layers. The AP 350 may also include medium access control layer (MAC) circuitry 354 for controlling access to the wireless medium. The AP 350 may also include processing circuitry 356 and memory 358 arranged to perform the operations described herein.

The antennas 301, 351, 230 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 301, 351, 230 may be effectively separated to take advantage of spatial diversity and the different channel characteristics that may result.

In some embodiments, the STA 300 may be configured as an HEW device 104 (FIG. 1), and may communicate using OFDM and/or OFDMA communication signals over a multicarrier communication channel. In some embodiments, the AP 350 may be configured to communicate using OFDM and/or OFDMA communication signals over a multicarrier communication channel. In some embodiments, the HEW device 104 may be configured to communicate using OFDM communication signals over a multicarrier communication channel. Accordingly, in some cases, the STA 300, AP 350 and/or HEW device 104 may be configured to receive signals in accordance with specific communication standards, such as the Institute of Electrical and Electronics Engineers (IEEE) standards including IEEE 802.11-2012, 802.11n-2009 and/or 802.11ac-2013 standards and/or proposed specifications for WLANs including proposed HEW standards, although the scope of the embodiments is not limited in this respect as they may also be suitable to transmit and/or receive communications in accordance with other techniques and standards. In some other embodiments, the AP 350, HEW device 104 and/or the STA 300 configured as an HEW device 104 may be configured to receive signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect. Embodiments disclosed herein provide two preamble formats for High Efficiency (HE) Wireless LAN standards specification that is under development in the IEEE Task Group 11ax (TGax).

In some embodiments, the STA 300 and/or AP 350 may be a mobile device and may be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly. In some embodiments, the STA 300 and/or AP 350 may be configured to operate in accordance with 802.11 standards, although the scope of the embodiments is not limited in this respect. Mobile devices or other devices in some embodiments may be configured to operate according to other protocols or standards, including other IEEE standards, Third Generation Partnership Project (3GPP) standards or other standards. In some embodiments, the STA 300 and/or AP 350 may include one or more of a keyboard, a display, a non-volatile memory port, multiple antennas, a graphics processor, an application processor, speakers, and other mobile device elements. The display may be an LCD screen including a touch screen.

Although the STA 300 and the AP 350 are each illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

It should be noted that in some embodiments, an apparatus used by the STA 300 may include various components of the STA 300 as shown in FIG. 3 and/or the example machine 200 as shown in FIG. 2. Accordingly, techniques and operations described herein that refer to the STA 300 (or 103) may be applicable to an apparatus for an STA, in some embodiments. It should also be noted that in some embodiments, an apparatus used by the AP 350 may include various components of the AP 350 as shown in FIG. 3 and/or the example machine 200 as shown in FIG. 2. Accordingly, techniques and operations described herein that refer to the AP 350 (or 102) may be applicable to an apparatus for an AP, in some embodiments. In addition, an apparatus for a mobile device and/or base station may include one or more components shown in FIGS. 2-3, in some embodiments. Accordingly, techniques and operations described herein that refer to a mobile device and/or base station may be applicable to an apparatus for a mobile device and/or base station, in some embodiments.

In accordance with some embodiments, the AP 102 may transmit a trigger frame (TF) that indicates a resource unit (RU) to be used by the STA 103 for an uplink data transmission. The AP 102 may transmit a downlink data packet that indicates an RU to be used by the STA 103 for a transmission of an acknowledgement message. In these and other cases, an RU allocation index may be used to indicate the RU. In addition, a group of one or more spatial streams (SSs) to be used by the STA 103 for the uplink data transmission may be included in the TF. These embodiments will be described in more detail below.

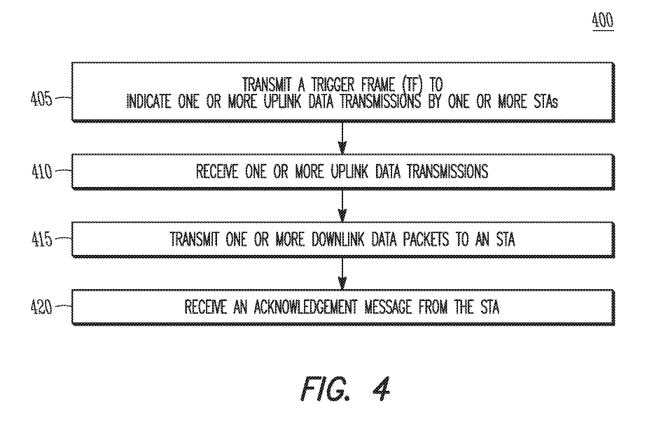

FIG. 4 illustrates the operation of a method of communication in accordance with some embodiments. It is important to note that embodiments of the method 400 may include additional or even fewer operations or processes in comparison to what is illustrated in FIG. 4. In addition, embodiments of the method 400 are not necessarily limited to the chronological order that is shown in FIG. 4. In describing the method 400, reference may be made to FIGS. 1-3 and 5-13, although it is understood that the method 400 may be practiced with any other suitable systems, interfaces and components.

In some embodiments, the STA 103 may be configurable to operate as an HEW device 104. Although reference may be made to an STA 103 herein, including as part of the descriptions of the method 400 and/or other methods described herein, it is understood that an HEW device 104 and/or STA 103 configurable to operate as an HEW device 104 may be used in some embodiments. In addition, the method 400 and other methods described herein may refer to STAs 103, HEW devices 104 and/or APs 102 operating in accordance with one or more standards and/or protocols, such as 802.11, Wi-Fi, wireless local area network (WLAN) and/or other, but embodiments of those methods are not limited to just those devices. In some embodiments, the method 400 and other methods described herein may be practiced by other mobile devices, such as an Evolved Node-B (eNB) or User Equipment (UE). The method 400 and other methods described herein may also be practiced by wireless devices configured to operate in other suitable types of wireless communication systems, including systems configured to operate according to various Third Generation Partnership Project (3GPP) Long Term Evolution (LTE) standards. The method 400 may also be applicable to an apparatus for an STA 103, HEW device 104 and/or AP 102 or other device described above, in some embodiments.

It should also be noted that embodiments are not limited by references herein (such as in descriptions of the methods 400, 1300 and/or other descriptions herein) to transmission, reception and/or exchanging of elements such as frames, messages, requests, indicators, signals or other elements. In some embodiments, such an element may be generated, encoded or otherwise processed by processing circuitry (such as by a baseband processor included in the processing circuitry) for transmission. The transmission may be performed by a transceiver or other component, in some cases. In some embodiments, such an element may be decoded, detected or otherwise processed by the processing circuitry (such as by the baseband processor). The element may be received by a transceiver or other component, in some cases. In some embodiments, the processing circuitry and the transceiver may be included in a same apparatus. The scope of embodiments is not limited in this respect, however, as the transceiver may be separate from the apparatus that comprises the processing circuitry, in some embodiments.

At operation 405 of the method 400, the AP 102 may transmit a trigger frame (TF) to one or more STAs 103. In some embodiments, the TF may indicate that the one or more STAs 103 are to perform uplink data transmissions and may include related control information. In some cases, the TF may initiate the uplink data transmissions. At operation 410, the AP 102 may receive one or more uplink data signals from the one or more STAs 103. In some cases, the reception of the uplink data signals may be performed in accordance with the control information included in the TF, although embodiments are not limited as such.

In some embodiments, the uplink data signal may be an orthogonal frequency division multiple access (OFDMA) signal. The scope of embodiments is not limited in this respect, however, as other signals may be used, including but not limited to SC-FDMA signals and/or other signals.

It should be noted that in some embodiments, other uplink signals (such as control signals, acknowledgement signals and/or other signals) may be received from the STA 103. That is, the TF may be used to indicate that the STA 103 is to transmit other types of uplink signals, in some embodiments. Accordingly, references herein to uplink data signals are not limiting, as some operations and/or techniques may be applicable to embodiments in which other types of uplink signals are indicated by the TF and/or received from the STA 103.

As an example, the TF may include information related to one or more resource units (RU) to be used by one or more STAs 103 for one or more uplink data transmissions, including but not limited to uplink OFDMA transmissions. For instance, an RU allocation index may be included, examples of which will be described below. Accordingly, the STA 103 may transmit an OFDMA signal in accordance with the RU(s) indicated by the TF. In addition, the AP 102 may receive such an OFDMA signal in accordance with the RU(s) indicated by the TF.

As another example, the TF may include information related to one or more spatial stream (SS) to be used by one or more STAs 103 for one or more uplink data transmissions. For instance, an SS allocation block may be included, examples of which will be described below. Such transmissions may include, but are not limited to, uplink transmissions in accordance with a multiple user multiple input multiple output (MU-MIMO) arrangement. The uplink transmissions may be in accordance with OFDMA, in some embodiments. In some embodiments, the STA 103 may transmit an OFDMA signal in an RU indicated in the TF in accordance with a group of SSs indicated in the TF.

In some embodiments, the SS allocation block may indicate one or more SSs to be used by the STA 103. The SSs may be in a group of candidate SSs of the STA 103 that are mapped to transmission paths of the STA 103, in some embodiments. As a non-limiting example, the SS allocation block may include an SS number and a starting SS. The indicated group of SSs indicated by the SS allocation block may include the candidate SSs that are mapped to a group of SS indexes. The group of SS indexes may be a consecutive group of size SS number that starts with the starting SS. It should be noted that this example SS allocation block is not limiting, as other techniques may be used to indicate a group of SSs to be used by the STA 103.

It should be noted that these examples of information that may be included in the TF are not limiting, as the TF may include other information, in some embodiments.

It should be noted that the TF may be or may include a uni-cast IF, a multi-cast TF and/or other type of TF. As an example, the TF may be configurable to indicate to any number of STAs 103 (such as one or more) that uplink data transmission(s) are to be performed. As another example, the TF may be or may include a uni-cast TF that may be transmitted to an STA 103 to indicate that STA 103 is to perform one or more uplink transmissions. In some cases, the STA 103 may perform the one or more uplink transmissions in accordance with control information included in the uni-cast TF.

As another example, the TF may be or may include a multi-cast TF that may be transmitted to a group of STAs 103 to indicate that one or more of the STAs 103 are to perform one or more uplink transmissions. In some cases, the STA 103 may perform the one or more uplink transmissions in accordance with control information included in the multi-cast TF. The control information may include control information for each STA 103 in some cases, such as a per user information block, although embodiments are not limited as such.

In some cases, the TF (uni-cast, multi-cast and/or other type of TF) may also include common control information which may not necessarily be dedicated to any particular STA 103. In addition, uplink data transmissions may be performed, in some cases, in accordance with such common control information and/or dedicated control information (such as per STA 103 control information). Examples of common control information may include configuration information, system information and/or other information that may not necessarily be specific to the intended uplink data transmission indicated by the TFs.

Returning to the method 400, at operation 415, the AP 102 may transmit one or more downlink data packets to the STA 103. At operation 420, the AP may receive, from the STA 103, a block acknowledgement (BA) message for the downlink data packet(s). The BA message may include one or more acknowledgements of one or more downlink data packets. Embodiments are not limited to BA messages, however, as other acknowledgement messages may be used in some cases.

In some embodiments, the data packets may be HE data packets that may include a high efficiency (HE) header. The HE header may include an RU allocation index to indicate an RU in which the STA 103 is to transmit the BA message, in some cases. Although embodiments are not limited as such, uplink OFDMA may be used for the BA message. In some embodiments, techniques and/or operations related to the RU allocation index included in the TF at operation 405 may be used for the RU allocation index of the HE header, although the scope of embodiments is not limited in this respect.

It should be noted that some embodiments may not necessarily include all operations shown in FIG. 4. Some embodiments may include operations 405 and 410 and may exclude operations 415 and 420, such as when uplink data transmission is performed and downlink data transmission is not performed. Some embodiments may exclude operations 405 and 410 and may include operations 415 and 420, such as when downlink data transmission is performed and uplink data transmission is not performed.

Some embodiments may include operations 405-420, such as when uplink data transmission and downlink data transmission are performed. As an example, the TF transmitted at operation 405 may indicate a first RU to be used by the STA 103 for an uplink data transmission at operation 410. The downlink data packet transmitted by the AP 102 at operation 405 may indicate a second RU (which may or may not be the same as the first RU) to be used by the STA 103 for the transmission of the BA message at operation 420. It should also be noted that embodiments are not limited to the ordering of operations shown in FIG. 4 in these examples and in other scenarios.

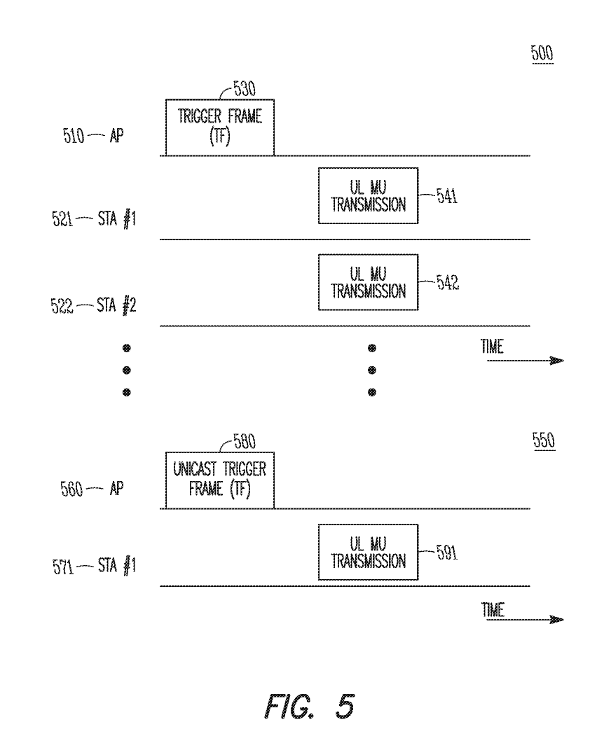

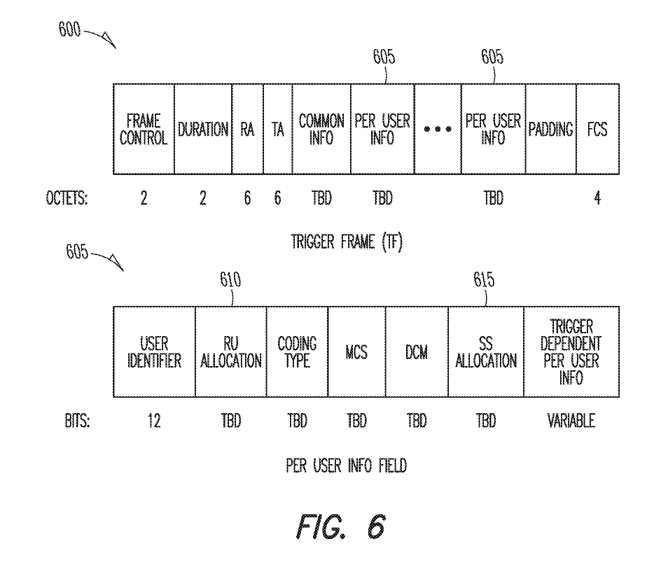

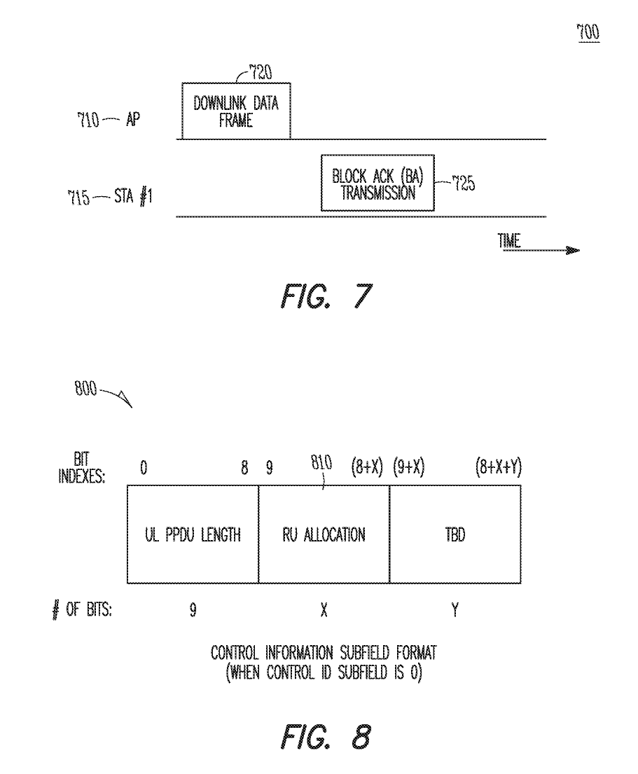

FIGS. 5 and 7 illustrate example frames and packets that may be exchanged in accordance with some embodiments. FIGS. 6 and 8 illustrate example control fields in accordance with some embodiments. It should be noted that the examples shown in FIGS. 5-8 may illustrate some or all of the concepts and techniques described herein in some cases, but embodiments are not limited by the examples. For instance, embodiments are not limited by the name, number, type, size, ordering, arrangement and/or other aspects of the frames, signals, data blocks, control headers and other elements as shown in FIGS. 5-8. In addition, embodiments are also not limited to the number of STAs 103 used in any of the examples shown in FIGS. 5-8. Although some of the elements shown in the examples of FIGS. 5-8 may be included in an 802.11 standard and/or other standard, embodiments are not limited to usage of such elements that are included in standards.

In the example scenario 500, two STAs 521 and 522 are shown, but it is understood that embodiments may be extended to include more than two STAs. The AP 510 may transmit a TF 530 to initiate and/or trigger UL transmissions by the STAs 521, 522. UL transmissions 541 and 542 may be performed by the STAs 521, 522 in accordance with information included in the TF 530. In this scenario, the TF 530 may be a multi-cast TF and/or may include multi-cast information.

In the example scenario 550, the AP 560 may transmit a TF 580 to initiate and/or trigger a UL transmission by the STA 571. The UL transmission 591 may be performed by the STA 571 in accordance with information included in the TF 580. In this scenario, the TF 580 may be a unicast TF and/or may include unicast information.

The example TF 600 illustrated in FIG. 6 may be transmitted by the AP 102 to indicate per user information 605 for one or more STAs 103. Accordingly, a per user information block 605 may be included in the TF 600 for each of those STAs 103, in some embodiments. The per user information block 605 illustrated in the bottom portion of FIG. 6 may include an RU allocation block 610 and/or an SS allocation block 615. The RU allocation block 610 of a per user info block 605 for a particular STA 103 may indicate an RU to be used by the STA 103. In some embodiments, the RU allocation block 610 may be or may include an RU allocation index, such as those in the examples below. The SS allocation block 615 of a per user info block 605 for a particular STA 103 may indicate a group of one or more SSs to be used by the STA 103. In some embodiments, the SS allocation block 615 may include one or more fields such as the SS number, starting SS and/or others as described in the examples below.

It should be noted that the example TF 600 may include various fields as shown in FIG. 6, such as frame control, duration, RA, TA, common info, padding, and FCS. In addition, the example per user info block 605 may include various fields as shown, such as a user identifier, coding type, MCS, DCM, and trigger dependent per user info. However, it is understood that, in some embodiments, the TF and/or per user info block 605 may not necessarily include all of the fields shown in FIG. 6 and may even include additional fields.

In the example scenario 700, the AP 710 may transmit a downlink data frame 720 to the STA 715, which may transmit a BA message 725 (or other acknowledgement message) that includes acknowledgement(s) of downlink data packets/frames. The BA transmission 725 may be performed by the STA 715 in accordance with information included in the downlink data frame 720 (such as in an HE header). For instance, an RU allocation index may indicate an RU to be used for an OFDMA transmission of the BA transmission 725, in some cases.

The example HE header 800 illustrated in FIG. 8 may be transmitted by the AP 102 as part of a downlink data block, in some cases. The RU allocation block 810 may indicate an RU to be used by the STA 103 for a transmission of a BA message and/or other acknowledgement message. In some embodiments, the RU allocation block 810 may be or may include an RU allocation index, such as those in the examples below. It should be noted that the example HE header 800 may include various fields as shown in FIG. 8, such as a UL PPDU length. However, it is understood that, in some embodiments, the HE header 800 may not necessarily include all of the fields shown in FIG. 8 and may even include additional fields, in some cases.

It should also be noted that in some cases, frames and/or elements (including but not limited to those in FIGS. 5 and 7) may be transmitted in accordance with contention based techniques. In some embodiments, a transmission of a frame and/or element may be performed after detection of an inactivity period of the channel to be used for the transmission. For instance, it may be determined, based on channel sensing, that the channel is available. As a non-limiting example, a minimum time duration for the inactivity period may be based on an inter-frame spacing (IFS), which may be included in an 802.11 standard and/or other standard. That is, when inactivity is detected for a time duration that is greater than or equal to the IFS, the channel may be determined to be available. Embodiments are not limited to usage of the IFS, however, as other time durations, which may or may not be included in a standard, may be used in some cases. In addition, back-off techniques may also be used, in some embodiments.

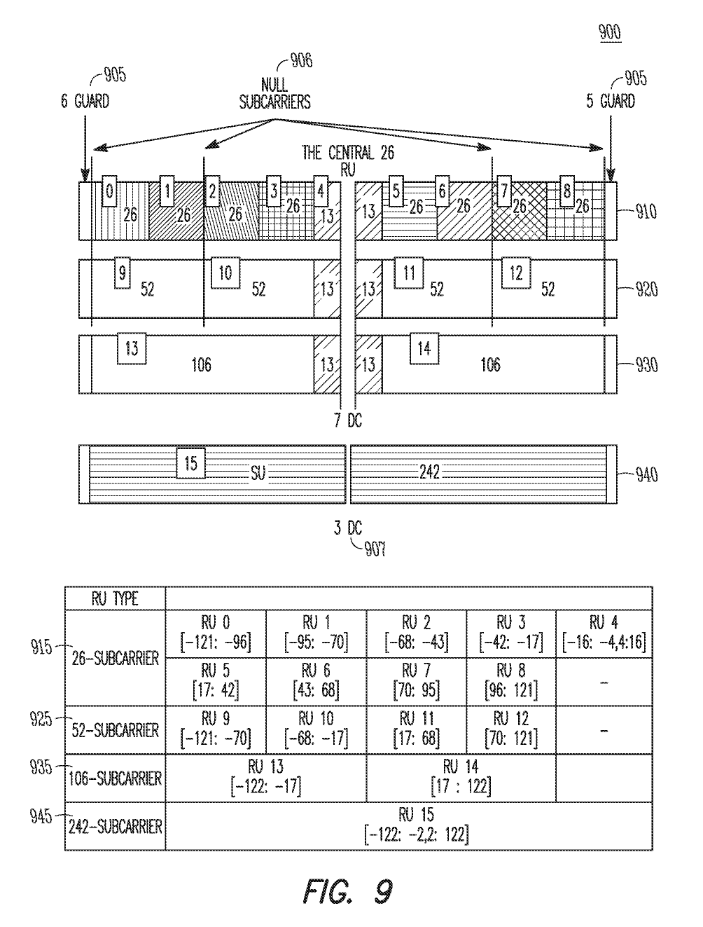

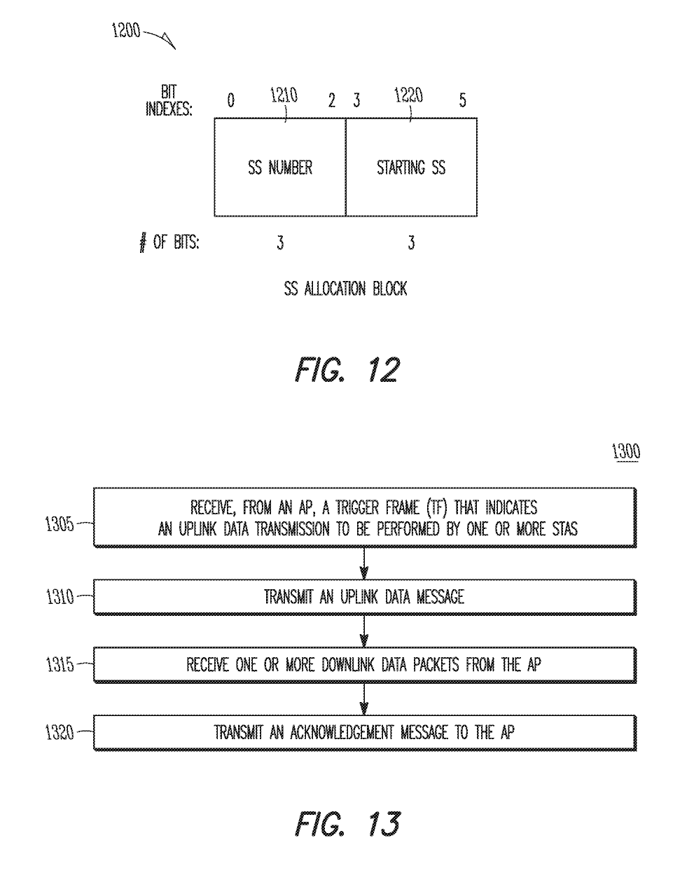

FIGS. 9-11 illustrate example assignments of indexes in accordance with some embodiments. FIG. 12 illustrates an example allocation block in accordance with some embodiments. It should be noted that the examples shown in FIGS. 9-12 may illustrate some or all of the concepts and techniques described herein in some cases, but embodiments are not limited by the examples. For instance, embodiments are not limited by the name, number, type, size, ordering, arrangement and/or other aspects of the channel resources, indexes, control blocks, bandwidths, RUs, sub-carriers, sub-carrier spacing, DC sub-carriers, null sub-carriers, guard sub-carriers and other elements as shown in FIGS. 9-12. In addition, the values used in the example mappings are not limiting. For instance, the particular mappings of index values to RUs shown in the examples of FIGS. 9-11 are not limiting. The mapping between groups of SSs and the parameters of the SS allocation block shown in FIG. 12 are also not limiting. It should also be noted that some of the elements shown in the examples of FIGS. 9-12 may be included in an 802.11 standard and/or other standard, but embodiments are not limited to those standards. Embodiments are also not limited to usage of elements that are included in standards.

In some embodiments, OFDMA signals may be exchanged between the AP 102 and one or more STAs 103. Channel resources (such as a frequency band available for usage) may be divided, allocated and/or partitioned into portions that may include RUs, sub-carriers, sub-channels, groups of sub-carriers and/or other frequency unit. Although embodiments are not limited as such, the portions may be non-overlapping, in some embodiments. For instance, non-overlapping RUs may be used. In addition, the RUs may include non-overlapping sub-carriers, in some embodiments.

As an example, a first portion (such as a first group of one or more RUs) of the channel resources may be used by a first STA 103 for transmission of a first uplink OFDMA signal and a second portion of the channel resources (such as a second group of one or more RUs) may be used by a second STA 103 for transmission of a second uplink OFDMA signal. This example is not limited to two STAs 103, however, and may be extended to accommodate more than two STAs 103. In some cases, a single STA 103 may transmit.

Although the portions of channel resources allocated to the STAs 103 may include one or more RUs, embodiments are not limited as such. In some embodiments, any suitable division of the channel resources into portions for allocation to different STAs 103 may be used. As an example, portions of non-uniform bandwidths may be used. In addition, the STAs 103 may transmit signals in such portions that may not necessarily be OFDMA in some embodiments. It is understood, therefore, that examples of allocation of RUs for OFDMA transmission are not limiting.

Referring to FIG. 9, an example 900 of an RU allocation index assignment for a 20 MHz channel is shown. The 20 MHz channel comprises 256 sub-carriers spaced by 78.125 kHz. The channel includes 6 guard sub-carriers 905 at the lower edge and 5 guard sub-carriers 905 at the upper edge, 7 or 3 DC sub-carriers. In some cases, null sub-carriers 906 may be included at various locations.

Different RU sizes may be used, in some embodiments, such as shown in FIG. 9. Accordingly, the RUs of different sizes may include different numbers of sub-carriers. The RUs may include 26, 52, 106 or 242 sub-carriers, which may correspond to bandwidths of 2.03125, 4.0625, 8.28125, and 18.90625 MHz, respectively. It should be noted that the RUs are not necessarily contiguous in frequency. As an example, one of the RUs of 26 sub-carriers (indexed as “4”) includes 13 sub-carriers immediately below the DC sub-carriers 907 and 13 sub-carriers immediately above the DC sub-carriers 907. As another example, the RU of 242 sub-carriers (indexed as “15”) includes 121 sub-carriers on each side of the three DC sub-carriers 907. However, sub-carriers of other RUs (such as those indexed as 0-3 and those indexed as 5-14) may be contiguous in frequency.

As an example, an RU allocation index between 0 and 15 may be assigned to 16 different variable bandwidth RUs. Accordingly, 4 bits may be used to represent the 16 RU allocation indexes, in this case, although more than 4 bits may also be used in some cases. In some embodiments, the RU allocation index included in the TF or other element may be one of a group of candidate RU allocation indexes (such as all possible values for the RU allocation index). For instance, the group of candidate RU allocation indexes may be values in the range of 0-15 in the example 900. It should be noted that in some cases, more RUs than shown in the example 900 may be allocated, such as when the channel resources include multiple 20 MHz channels or channels larger than 20 MHz. In such cases, more than 4 bits may be used in the RU allocation index. Mappings and/or techniques described for the example 20 MHz channel may be extended for such cases, although embodiments are not limited as such.

As indicated by 910 and 915, the channel resources may be divided, allocated and/or partitioned to include nine RUs of 26 sub-carriers, seven DC sub-carriers 907, four null sub-carriers 906, and the guard-bands 905. The nine RUs of 26 sub-carriers may be indexed as 0-8 as shown. Accordingly, a first portion (such as 0-8) of the candidate RU allocation indexes (such as 0-15) may be mapped in accordance with a first division of the channel resources into a first group of one or more RUs of a first predetermined bandwidth (such as 2.03125 MHz) and/or a first predetermined number of sub-carriers (such as 26). In some embodiments, the first portion (such as 0-8) of the candidate RU allocation indexes (such as 0-15) may be mapped in accordance with a first allocation of the channel resources into a first group of one or more RUs of a first predetermined bandwidth (such as 2.03125 MHz) and/or a first predetermined number of sub-carriers (such as 26). It should also be noted that the RU allocation indexes of the first portion (such as 0-8) may be mapped to a first group of one or more RUs (such as the nine RUs of 26 sub-carriers shown) in accordance with a predetermined mapping, in some embodiments. For instance, the assignment of the indexes 0-8 to the nine RUs of 26 sub-carriers as shown in FIG. 9 may be used, in some cases.

As indicated by 920 and 925, the channel resources may be divided, allocated and/or partitioned to include four RUs of 52 sub-carriers, seven DC sub-carriers 907, four null sub-carriers 906, and the guard-bands 905. The four RUs of 52 sub-carriers may be indexed as 9-12 as shown. Accordingly, a second portion (such as 9-12) of the candidate RU allocation indexes (such as 0-15) may be mapped in accordance with a second division of the channel resources into a second group of one or more RUs of a second predetermined bandwidth (such as 4.0625 MHz) and/or a second predetermined number of sub-carriers (such as 52). In some embodiments, the second portion (such as 9-12) of the candidate RU allocation indexes (such as 0-15) may be mapped in accordance with a second allocation of the channel resources into a second group of one or more RUs of a second predetermined bandwidth (such as 4.0625 MHz) and/or a second predetermined number of sub-carriers (such as 52). It should also be noted that the RU allocation indexes of the second portion (such as 9-12) may be mapped to a second group of one or more RUs (such as the four RUs of 52 sub-carriers shown) in accordance with a predetermined mapping, in some embodiments. For instance, the assignment of the indexes 9-12 to the four RUs of 52 sub-carriers as shown in FIG. 9 may be used, in some cases.

As indicated by 930 and 935, the channel resources may be divided, allocated and/or partitioned to include two RUs of 106 sub-carriers, seven DC sub-carriers 907, and the guard-bands 905. The two RUs of 106 sub-carriers may be indexed as 13-14 as shown. Accordingly, a third portion (such as 13-14) of the candidate RU allocation indexes (such as 0-15) may be mapped in accordance with a third division of the channel resources into a third group of one or more RUs of a third predetermined bandwidth (such as 8.28125 MHz) and/or a third predetermined number of sub-carriers (such as 106). In some embodiments, the third portion (such as 13-14) of the candidate RU allocation indexes (such as 0-15) may be mapped in accordance with a third allocation of the channel resources into a third group of one or more RUs of a third predetermined bandwidth (such as 8.28125) and/or a third predetermined number of sub-carriers (such as 106). It should also be noted that the RU allocation indexes of the third portion (such as 13-14) may be mapped to a third group of one or more RUs (such as the two RUs of 106 sub-carriers shown) in accordance with a predetermined mapping, in some embodiments. For instance, the assignment of the indexes 13-14 to the two RUs of 106 sub-carriers as shown in FIG. 9 may be used, in some cases.

As indicated by 940 and 945, the channel resources may be divided, allocated and/or partitioned to include one RU of 242 sub-carriers, three DC sub-carriers 907, and the guard-bands 905. The RU of 242 sub-carriers may be indexed as 15 as shown. Accordingly, a fourth portion (such as the index 15) of the candidate RU allocation indexes (such as 0-15) may be mapped in accordance with a fourth division of the channel resources into a fourth group of one or more RUs of a fourth predetermined bandwidth (such as 18.90625 MHz) and/or a fourth predetermined number of sub-carriers (such as 242). In some embodiments, the fourth portion (such as the index 15) of the candidate RU allocation indexes (such as 0-15) may be mapped in accordance with a fourth allocation of the channel resources into a fourth group of one or more RUs of a fourth predetermined bandwidth (such as 18.90625 MHz) and/or a fourth predetermined number of sub-carriers (such as 242). It should also be noted that the RU allocation indexes of the fourth portion (such as the index 15) may be mapped to a fourth group of one or more RUs (such as the RU of 242 sub-carriers shown) in accordance with a predetermined mapping, in some embodiments. For instance, the assignment of the index 15 to the RU of 242 sub-carriers as shown in FIG. 9 may be used, in some cases.

In some embodiments, a bandwidth of the channel resources may be one of 20, 40, 80 or 160 MHz. A mapping of RU allocation index to RUs may be different for the different bandwidths. Techniques described for the 20 MHz channel, such as in FIG. 9, may be extended and/or modified to accommodate the other possible bandwidths. As a non-limiting example, a mapping of RU allocation index to RUs may be based on possible RU allocations for all of the above bandwidths (20, 40, 80 and 160 MHz).

In some embodiments, a first group of possible RU allocation indexes may be allocated for a first bandwidth of channel resources. The RU allocation indexes of the first group may be mapped to different RUs (such as RUs of variable sizes, variable RU bandwidths and/or variable number of sub-carriers) based on different divisions/partitions of the channel resources of the first bandwidth. As will be seen in the examples of FIGS. 9-11, a group of 16 RU allocation indexes may be allocated for a 20 MHz bandwidth of channel resources. A second group of possible RU allocation indexes (non-overlapping with the first group) may be allocated for a second bandwidth of channel resources. The RU allocation indexes of the second group may be mapped to different RUs (such as RUs of variable sizes, variable RU bandwidths and/or variable number of sub-carriers) based on different divisions/partitions of the channel resources of the second bandwidth. As will be seen in the examples of FIGS. 9-11, a group of 33 RU allocation indexes (exclusive to the 16 indexes allocated for the 20 MHz bandwidth of channel resources) may be allocated for a 40 MHz bandwidth of channel resources. A third group of possible RU allocation indexes (non-overlapping with the first and second groups) may be allocated for a third bandwidth of channel resources. The RU allocation indexes of the third group may be mapped to different RUs (such as RUs of variable sizes, variable RU bandwidths and/or variable number of sub-carriers) based on different divisions/partitions of the channel resources of the third bandwidth. As will be seen in the examples of FIGS. 9-11, a group of 68 RU allocation indexes (exclusive to the 16 indexes allocated for the 20 MHz bandwidth of channel resources and exclusive to the 33 indexes allocated for the 40 MHz bandwidth of channel resources) may be allocated for an 80 MHz bandwidth of channel resources. Such examples may be extended beyond the three groups, in some cases.

Referring to FIG. 9, an example mapping 900 for a 20 MHz bandwidth of the channel resources is shown. In the example mapping 900, 16 possible combinations of RU sizes include nine RUs of 26 sub-carriers (RU0-RU8, as indicated by 915), four RUs of 52 sub-carriers (RU9-RU12, as indicated by 925), two RUs of 106 sub-carriers (RU13-RU14, as indicated by 935), and one RU of 242 sub-carriers (RU15, as indicated by 945).

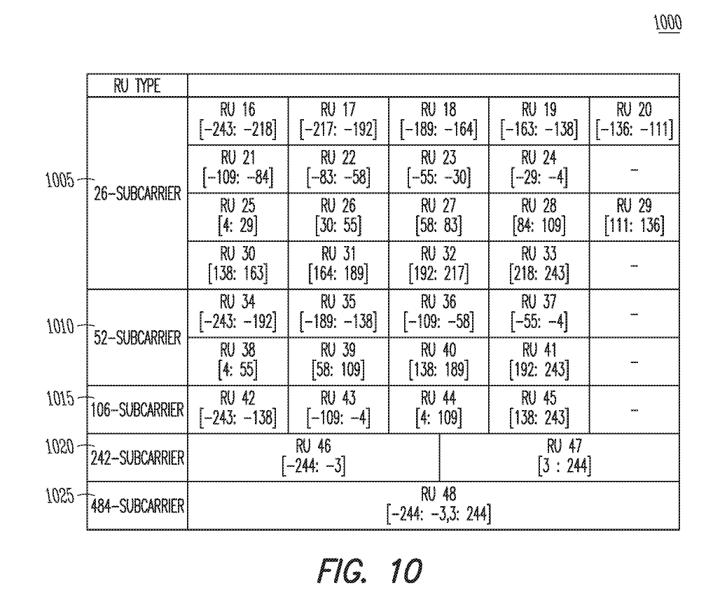

Referring to FIG. 10, an example mapping 1000 for a 40 MHz bandwidth of the channel resources is shown. In the example mapping 1000, 33 possible combinations of RU sizes include 18 RUs of 26 sub-carriers (RU16-RU33, as indicated by 1005), 8 RUs of 52 sub-carriers (RU34-RU41, as indicated by 1010), 4 RUs of 106 sub-carriers (RU42-RU45, as indicated by 1015), 2 RUs of 242 sub-carriers (RU46-RU47, as indicated by 1020), and one RU of 484 sub-carriers (RU48, as indicated by 1025). It should be noted that the RU allocation indexes for the 20 MHz bandwidth of the channel resources, RU0-RU15, are non-overlapping with the RU allocation indexes for the 40 MHz bandwidth of the channel resources, RU16-RU48.

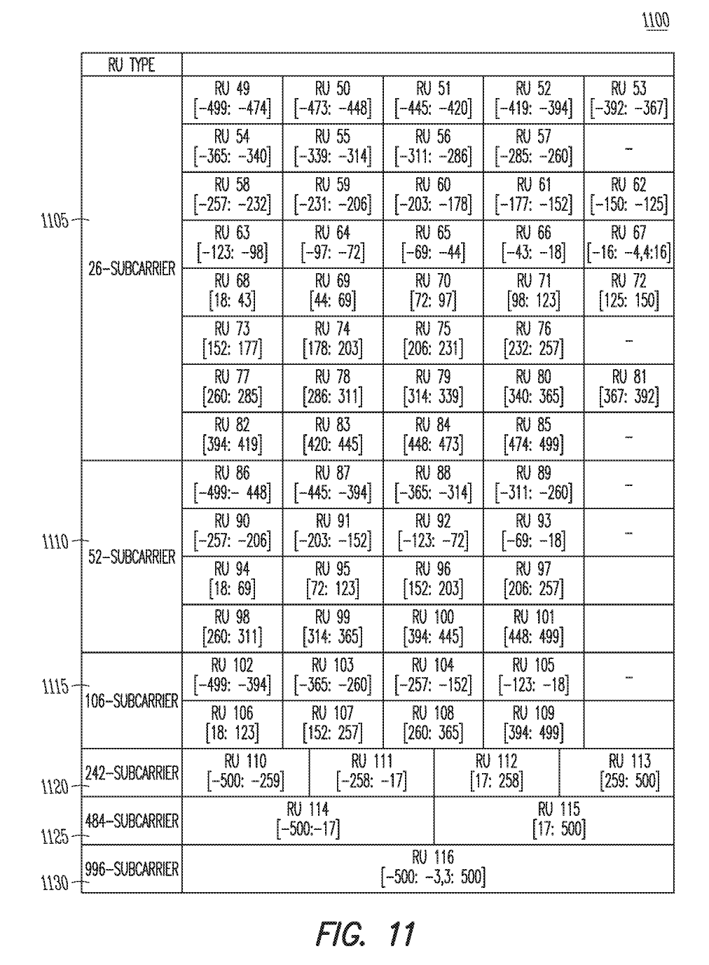

Referring to FIG. 11, an example mapping 1100 for an 80 MHz bandwidth of the channel resources is shown. In the example mapping 1100, 68 possible combinations of RU sizes include 37 RUs of 26 sub-carriers (RU49-RU85, as indicated by 1105), 16 RUs of 52 sub-carriers (RU86-RU101, as indicated by 1110), 8 RUs of 106 sub-carriers (RU102-RU109, as indicated by 1115), 4 RUs of 242 sub-carriers (RU110-RU113, as indicated by 1120), 2 RUs of 484 sub-carriers (RU114-RU115, as indicated by 1125), and one RU of 996 sub-carriers (RU116, as indicated by 1130). It should be noted that the RU allocation indexes for the 80 MHz bandwidth of the channel resources, RU49-RU116, are non-overlapping with the RU allocation indexes for the 40 MHz bandwidth of the channel resources, RU16-RU48, and are also non-overlapping with the RU allocation indexes for the 20 MHz bandwidth of the channel resources, RU0-RU15.

For a 160 MHz bandwidth, 136 possible combinations may be mapped to RU allocation indexes (such as 117-252). A lower 80 MHz of the 160 MHz may use the mapping of FIG. 11 for 80 MHz using the indexes 117-184 and an upper 80 MHz of the 160 MHz may use the mapping of FIG. 11 for 80 MHz using the indexes 185-252. Accordingly, the 253 RU allocations of different RU bandwidths in the four bandwidths of channel resources (20, 40, 80 and 160 MHz) may be represented using 8 bits, which may be included in a TF, in a UL MU response scheduling element of an HE variant HT control field and/or in another element.

It should be pointed out that in this example 900, in some cases (such as when RUs are allocated according to 920 or 930) the 26 sub-carriers comprising the 13 sub-carriers immediately below the DC sub-carriers 907 and the 13 sub-carriers immediately below the DC sub-carriers 907 may not necessarily be included in an RU in some cases. In some cases, those sub-carriers may be used for other purposes or may be unused.

In some embodiments, the channel resources of some RUs, such as RUs of different bandwidths and/or number of sub-carriers, may substantially overlap. As an example, referring to the example 900 in FIG. 9, the combined channel resources of the nine RUs of 26 sub-carriers indexed by 0-8 may substantially overlap the combined channel resources of the four RUs of 52 sub-carriers indexed by 9-12. For instance, in this particular example, the channel resources of the eight RUs indexed by 0-3 and 5-8 as indicated by 910 are identical (or nearly identical) to the channel resources of the four RUs indexed by 9-12 as indicated by 920. As another example, the channel resources of the two RUs indexed by 0 and 1 may substantially overlap (and/or may be identical to) the channel resources of the RU indexed by 9.

Referring to FIG. 12, an example SS allocation block 1200 may include an SS number 1210 and a starting SS 1220 as previously described. The group of one or more SSs allocated to an STA 103 may be restricted to SSs of a group of one or more consecutive indexes, in some cases. In some embodiments, the SS number 1210 may be indicated by and/or may include 3 bits, and the starting SS 1220 may be indicated by and/or may include 3 bits. Accordingly, 6 bits may be used for the SS allocation block 1200.

Various scenarios may be accommodated. As an example, when a total number of possible SSs is 8 and the STA 103 may be allocated up to 8 SSs, 3 bits may be used for the SS number 1210 and 3 bits may be used for the starting SS 1220, for a total of 6 bits. As another example, when a total number of possible SSs is 8 and the STA 103 may be allocated up to 4 SSs, 2 bits may be used for the SS number 1210 and 3 bits may be used for the starting SS 1220, for a total of 5 bits. These examples are not limiting, however, as other sizes may be used in some embodiments.

In some embodiments, a combined index may be used to indicate the RU and the group of SSs to be used by the STA 103. Accordingly, the RU allocation index and SS allocation block may be combined and/or merged to an index for different combinations of RU and SS.

FIG. 13 illustrates the operation of another method of communication in accordance with some embodiments. As mentioned previously regarding the method 400, embodiments of the method 1300 may include additional or even fewer operations or processes in comparison to what is illustrated in FIG. 13 and embodiments of the method 1300 are not necessarily limited to the chronological order that is shown in FIG. 13. In describing the method 1300, reference may be made to FIGS. 1-12, although it is understood that the method 1300 may be practiced with any other suitable systems, interfaces and components. In addition, embodiments of the method 1300 may be applicable to APs 102, STAs 103, UEs, eNBs or other wireless or mobile devices. The method 1300 may also be applicable to an apparatus for an AP 102, STA 103 and/or other device described above.

It should be noted that the method 1300 may be practiced by an STA 103 and may include exchanging of elements, such as frames, signals, messages and/or other elements, with an AP 102. Similarly, the method 400 may be practiced at an AP 102 and may include exchanging of such elements with an STA 103. In some cases, operations and techniques described as part of the method 400 may be relevant to the method 1300. In addition, embodiments of the method 1300 may include operations performed at the STA 103 that are reciprocal to or similar to other operations described herein performed at the AP 102. For instance, an operation of the method 1300 may include reception of a frame from the AP 102 by the STA 103 while an operation of the method 400 may include transmission of the same frame or similar frame by the AP 102.

In addition, previous discussion of various techniques and concepts may be applicable to the method 1300 in some cases, including TFs, uni-cast TFs, multi-cast TFs, broadcast TFs, acknowledgement messages, BA messages, HE headers, RUs, RU allocation indexes, SSs, SS allocation blocks, UL OFDMA, UL MU-MIMO and/or others. In addition, the examples shown in FIGS. 5-12 may also be applicable, in some cases, although the scope of embodiments is not limited in this respect.

At operation 1305, the STA 103 may receive, from the AP 102, a TF that indicates an uplink data transmission to be performed by the STA 103. The TF may be configurable to be a uni-cast TF, multi-cast TF or broadcast TF, in some embodiments. At operation 1310, the STA 103 may transmit an uplink data message to the AP 102. In some embodiments, uplink OFDMA may be used, and the uplink OFDMA transmission may be performed in accordance with an RU allocation index received in the TF. In some embodiments, the uplink data message may be transmitted in accordance with SS information included in the TF.

At operation 1315, the STA 103 may receive one or more downlink data packets from the AP 102. The STA 103 may transmit an acknowledgement message, such as a BA message and/or other, to the AP 102 at operation 1320. In some embodiments, the acknowledgement message may be transmitted in accordance with an RU allocation index included in a HE data header of the downlink data packet from the AP 102.

In Example 1, an apparatus for an access point (AP) may comprise memory. The apparatus may further comprise processing circuitry. The processing circuitry may be configured to encode, for transmission, a trigger frame (TF) that includes a resource unit (RU) allocation index that indicates an RU of channel resources to be used for an uplink orthogonal frequency division multiple access (OFDMA) data transmission by a station (STA). The processing circuitry may be further configured to decode an OFDMA signal received from the STA in the indicated RU. The RU allocation index may be one of a group of candidate RU allocation indexes. A first portion of the candidate RU allocation indexes may be mapped in accordance with a first division of the channel resources into a first group of RUs of a first predetermined RU bandwidth. A second portion of the candidate RU allocation indexes may be mapped in accordance with a second division of the channel resources into a second group of RUs of a second predetermined RU bandwidth.

In Example 2, the subject matter of Example 1, wherein the STA is a first STA. The TF may be configurable to be a uni-cast TF dedicated for the uplink OFDMA data transmission by the first STA. The TF may be further configurable to be a multi-cast TF to be transmitted to a group of STAs that includes the first STA. The multi-cast TF may include one or more other RU allocation indexes for one or more other uplink OFDMA data transmissions by the group of STAs.

In Example 3, the subject matter of one or any combination of Examples 1-2, wherein a bandwidth of the channel resources may be configurable to be one of a group of candidate channel resource bandwidths. For different candidate channel resource bandwidths, non-overlapping portions of the RU allocation indexes may be mapped in accordance with different divisions of the channel resources into RUs of different predetermined RU bandwidths.

In Example 4, the subject matter of one or any combination of Examples 1-3, wherein the group of candidate channel resource bandwidths may include 20, 40, 80 and 160 MHz. The different predetermined RU bandwidths may be in a group that includes 2.03125, 4.0625, 8.28125, and 18.90625 MHz.

In Example 5, the subject matter of one or any combination of Examples 1-4, wherein the STA is a first STA, the RU is a first RU, and the RU allocation index is a first RU allocation index. The processing circuitry may be further configured to encode, for transmission to a second STA, a downlink data packet that includes a high efficiency (HE) header that includes a second RU allocation index of the group of candidate RU allocation indexes. The second RU allocation index may indicate a second RU of the channel resources to be used for an uplink OFDMA transmission, by the second STA, of a block acknowledgement (BA) message for the downlink data packet.

In Example 6, the subject matter of one or any combination of Examples 1-5, wherein the TF may further include a spatial stream (SS) allocation block that indicates a group of one or more SSs of the STA that are to be used for the uplink OFDMA data transmission in accordance with a multiple user multiple input multiple output (MU-MIMO) arrangement. The group of SSs to be used may be in a group of candidate SSs of the STA that are mapped to transmission paths of the STA.

In Example 7, the subject matter of one or any combination of Examples 1-6, wherein the SS allocation block may include an SS number and a starting SS. The indicated group of SSs may include the candidate SSs that are mapped to a group of SS indexes. The group of SS indexes may be a consecutive group of size SS number that starts with the starting SS.

In Example 8, the subject matter of one or any combination of Examples 1-7, wherein the SS number may be indicated by three bits and may range between one and eight. The starting SS may be indicated by three bits and may range between one and eight.

In Example 9, the subject matter of one or any combination of Examples 1-8, wherein the indexes of the first portion may be mapped to the first group of RUs in accordance with a first predetermined mapping. The indexes of the second portion may be mapped to the second group of RUs in accordance with a second predetermined mapping.

In Example 10, the subject matter of one or any combination of Examples 1-9, wherein the RUs in the first group may be non-overlapping in frequency. The RUs in the second group may be non-overlapping in frequency. The RUs in the first group may include a first number of sub-carriers. The RUs in the second group may include a second number of sub-carriers.

In Example 11, the subject matter of one or any combination of Examples 1-10, wherein the group of candidate RU allocation indexes may include at least one additional index mapped to an RU of a third predetermined RU bandwidth.

In Example 12, the subject matter of one or any combination of Examples 1-11, wherein the first predetermined RU bandwidth may be 2.03125 MHz. The first group of RUs may include nine RUs, each comprising 26 non-overlapping sub-carriers. The second predetermined bandwidth may be 4.0625 MHz. The second group of RUs may include four RUs, each comprising 52 non-overlapping sub-carriers. A third portion of the candidate RU allocation indexes may be mapped to a third group of one or more RUs of a third predetermined bandwidth of 8.28125 MHz. The third group of RUs may include two RUs, each comprising 106 non-overlapping sub-carriers. A fourth portion of the candidate RU allocation indexes may be mapped to a fourth group of one RU of a fourth predetermined bandwidth of 18.90625 MHz. The fourth group of one RU may include an RU comprising 242 non-overlapping sub-carriers. The first, second, third and fourth portions of the candidate RU allocation indexes may be further allocated for a 20 MHz bandwidth of the channel resources.

In Example 13, the subject matter of one or any combination of Examples 1-12, wherein the bandwidth of the channel resources may be configurable to one of a candidate group of channel resource bandwidths that includes 20, 40, 80 and 160 MHz. The first, second, third and fourth portions of the candidate RU allocation indexes may be non-overlapping. Additional non-overlapping portions of the RU allocation indexes may be mapped for each of the candidate channel resource bandwidths in accordance with different divisions of the channel resources into RUs of predetermined RU bandwidths.

In Example 14, the subject matter of one or any combination of Examples 1-13, wherein the processing circuitry may include a baseband processor to encode the TF and to decode the OFDMA signal.

In Example 15, the subject matter of one or any combination of Examples 1-14, wherein the AP may be arranged to operate in accordance with a wireless local area network (WLAN) protocol.

In Example 16, the subject matter of one or any combination of Examples 1-15, wherein the apparatus may further include a transceiver to transmit the TF and to receive the OFDMA signal.

In Example 17, a non-transitory computer-readable storage medium may store instructions for execution by one or more processors to perform operations for communication by an access point (AP). The operations may configure the one or more processors to encode, for transmission, a trigger frame (TF) that includes a spatial stream (SS) allocation block that includes an SS number and a starting SS, the SS allocation block to indicate a group of one or more SSs of a station (STA) that are to be used for an uplink orthogonal frequency division multiple access (OFDMA) data transmission by the STA. The operations may further configure the one or more processors to decode, in accordance with the indicated group of SSs, one or more data streams of an OFDMA signal received from the STA. The indicated group of SSs may be in a group of candidate SSs of the STA that are mapped to transmission paths of the STA. The indicated group of SSs may include the candidate SSs that are mapped to a group of SS indexes. The group of SS indexes may be a consecutive group of size SS number that starts with the starting SS.

In Example 18, the subject matter of Example 17, wherein the SS number may be indicated by three bits and ranges between one and eight. The starting SS may be indicated by three bits and ranges between one and eight.

In Example 19, the subject matter of one or any combination of Examples 17-18, wherein the STA is a first STA. The TF may be a multi-cast TF to be transmitted to a group of STAs that includes the first STA. The TF may include one or more other SS allocation indexes for one or more other uplink OFDMA data transmissions by the group of STAs.

In Example 20, the subject matter of one or any combination of Examples 17-19, wherein the TF may be a uni-cast TF encoded for transmission to the STA.

In Example 21, the subject matter of one or any combination of Examples 17-20, wherein the operations may further configure the one or more processors to encode, for transmission, a resource unit (RU) allocation index that indicates an RU of channel resources to be used for the uplink OFDMA data transmission by the STA. The OFDMA signal may be further received from the STA in the indicated RU.

In Example 22, the subject matter of one or any combination of Examples 17-21, wherein the RU allocation index may be one of a group of candidate RU allocation indexes. A first portion of the candidate RU allocation indexes may be mapped in accordance with a first division of the channel resources into a first group of RUs of a first predetermined RU bandwidth. A second portion of the candidate RU allocation indexes may be mapped in accordance with a second division of the channel resources into a second group of RUs of a second predetermined RU bandwidth.

In Example 23, the subject matter of one or any combination of Examples 17-22, wherein the RU allocation index and the SS allocation block may be encoded jointly to a combined RU/SS index. For at least one combination of sizes of the group of candidate RU allocation indexes and group of candidate SSs, a number of bits used for the combined RU/SS index may be less than a sum of a number of bits used for the RU allocation index and a number of bits used for the SS allocation block.

In Example 24, the subject matter of one or any combination of Examples 17-23, wherein the AP may be arranged to operate in accordance with a wireless local area network (WLAN) protocol.

In Example 25, a method of communication at an access point (AP) may comprise encoding, for transmission to a station (STA), a downlink data packet that includes a high efficiency (HE) header. The method may further comprise decoding a block acknowledgement (BA) message from the STA that includes an acknowledgement indicator for the downlink data packet. The HE header may include a resource unit (RU) allocation index that indicates an RU of channel resources to be used for an uplink orthogonal frequency division multiple access (OFDMA) transmission of the BA message by the STA. The RU allocation index may be one of a group of candidate RU allocation indexes. A first portion of the candidate RU allocation indexes may be mapped in accordance with a first division of the channel resources into a first group of RUs of a first predetermined RU bandwidth. A second portion of the candidate RU allocation indexes may be mapped in accordance with a second division of the channel resources into a second group of RUs of a second predetermined RU bandwidth.

In Example 26, the subject matter of Example 25, wherein the first predetermined RU bandwidth may be 2.03125 MHz. The first group of RUs may include nine RUs, each comprising 26 non-overlapping sub-carriers. The second predetermined bandwidth may be 4.0625 MHz. The second group of RUs may include four RUs, each comprising 52 non-overlapping sub-carriers. A third portion of the candidate RU allocation indexes may be mapped to a third group of one or more RUs of a third predetermined bandwidth of 8.28125 MHz. The third group of RUs may include two RUs, each comprising 106 non-overlapping sub-carriers. A fourth portion of the candidate RU allocation indexes may be mapped to a fourth group of one RU of a fourth predetermined bandwidth of 18.90625 MHz. The fourth group of RUs may include an RU comprising 242 non-overlapping sub-carriers. The first, second, third and fourth portions of the candidate RU allocation indexes may be further allocated for a 20 MHz bandwidth of the channel resources.

In Example 27, the subject matter of one or any combination of Examples 25-26, wherein the bandwidth of the channel resources may be configurable to one of a candidate group of channel resource bandwidths that includes 20, 40, 80 and 160 MHz. The first, second, third and fourth portions of the candidate RU allocation indexes may be non-overlapping. Additional non-overlapping portions of the RU allocation indexes may be mapped in accordance with different divisions into RUs for each of the channel resource bandwidths of 40, 80 and 160 MHz. The divisions into RUs for the channel resource bandwidths of 40, 80 and 160 MHz may include divisions into RUs of predetermined RU bandwidths in a group that includes 2.03125, 4.0625, 8.28125, and 18.90625 MHz.

In Example 28, an apparatus for a station (STA) may comprise memory. The apparatus may further comprise processing circuitry. The processing circuitry may be configured to decode a downlink message from an access point (AP). The downlink message may include a resource unit (RU) allocation index that indicates an RU of channel resources to be used for an uplink orthogonal frequency division multiple access (OFDMA) transmission by the STA. The downlink message may further include a spatial stream (SS) allocation block that indicates a group of one or more SSs of the STA to be used for the uplink OFDMA transmission. The processing circuitry may be further configured to encode an uplink message to be transmitted to the AP in accordance with the indicated RU and the indicated group of SSs. The RU allocation index may be one of a group of candidate RU allocation indexes mapped to RUs of variable RU bandwidths. The channel resources of the RUs of a first RU bandwidth may substantially overlap the channel resources of the RUs of a second RU bandwidth. The group of one or more SSs to be used may be in a group of candidate SSs of the STA that are mapped to transmission paths of the STA.

In Example 29, the subject matter of Example 28, wherein the RU allocation index and the SS allocation block may be included in an information block dedicated to the STA. The uplink OFDMA transmission may be in a group that includes an uplink data transmission and an uplink block acknowledgement (BA) transmission. When the uplink OFDMA transmission is an uplink data transmission, the information block may be included in a trigger frame (TF) that indicates that the STA is to perform the uplink data transmission. When the uplink OFDMA transmission is an uplink BA transmission, the information block may be included in a high efficiency (HE) header of a downlink data packet that is to be acknowledged by the STA in the uplink BA transmission.

In Example 30, the subject matter of one or any combination of Examples 28-29, wherein the processing circuitry may include a baseband processor to decode the downlink message and to encode the uplink message.

In Example 31, the subject matter of one or any combination of Examples 28-30, wherein the STA may be arranged to operate in accordance with a wireless local area network (WLAN) protocol.

In Example 32, the subject matter of one or any combination of Examples 28-31, wherein the apparatus may further include a transceiver to receive the downlink message and to transmit the uplink message.

In Example 33, an apparatus for an access point (AP) may comprise means for encoding, for transmission, a trigger frame (TF) that includes a resource unit (RU) allocation index that indicates an RU of channel resources to be used for an uplink orthogonal frequency division multiple access (OFDMA) data transmission by a station (STA). The apparatus may further comprise means for decoding an OFDMA signal received from the STA in the indicated RU. The RU allocation index may be one of a group of candidate RU allocation indexes. A first portion of the candidate RU allocation indexes may be mapped in accordance with a first division of the channel resources into a first group of RUs of a first predetermined RU bandwidth. A second portion of the candidate RU allocation indexes may be mapped in accordance with a second division of the channel resources into a second group of RUs of a second predetermined RU bandwidth.

In Example 34, the subject matter of Example 33, wherein a bandwidth of the channel resources may be configurable to be one of a group of candidate channel resource bandwidths. For different candidate channel resource bandwidths, non-overlapping portions of the RU allocation indexes may be mapped in accordance with different divisions of the channel resources into RUs of different predetermined RU bandwidths.

In Example 35, the subject matter of one or any combination of Examples 33-34, wherein the group of candidate channel resource bandwidths may include 20, 40, 80 and 160 MHz. The different predetermined RU bandwidths may be in a group that includes 2.03125, 4.0625, 8.28125, and 18.90625 MHz.

In Example 36, an apparatus for a station (STA) may comprise means for decoding a downlink message from an access point (AP), wherein the downlink message includes a resource unit (RU) allocation index that indicates an RU of channel resources to be used for an uplink orthogonal frequency division multiple access (OFDMA) transmission by the STA. The downlink message may further include a spatial stream (SS) allocation block that indicates a group of one or more SSs of the STA to be used for the uplink OFDMA transmission. The apparatus may further include means for encoding an uplink message to be transmitted to the AP in accordance with the indicated RU and the indicated group of SSs. The RU allocation index may be one of a group of candidate RU allocation indexes mapped to RUs of variable RU bandwidths. The channel resources of the RUs of a first RU bandwidth may substantially overlap the channel resources of the RUs of a second RU bandwidth. The group of one or more SSs to be used may be in a group of candidate SSs of the STA that are mapped to transmission paths of the STA.

In Example 37, the subject matter of Example 36, wherein the RU allocation index and the SS allocation block may be included in an information block dedicated to the STA. The uplink OFDMA transmission may be in a group that includes an uplink data transmission and an uplink block acknowledgement (BA) transmission. When the uplink OFDMA transmission may be an uplink data transmission, the information block is included in a trigger frame (TF) that indicates that the STA is to perform the uplink data transmission. When the uplink OFDMA transmission is an uplink BA transmission, the information block may be included in a high efficiency (HE) header of a downlink data packet that is to be acknowledged by the STA in the uplink BA transmission.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus for an access point (AP), the apparatus comprising: memory; and processing circuitry configured to:
encode, for transmission, a trigger frame (TF) that includes a resource unit (RU) allocation index that indicates an RU of channel resources to be used for an uplink orthogonal frequency division multiple access (OFDMA) data transmission by a station (STA); and
decode an OFDMA signal received from the STA in the indicated RU,
wherein the RU allocation index is one of a group of candidate RU allocation indexes,
wherein a first portion of the candidate RU allocation indexes are mapped in accordance with a first division of the channel resources into a first group of RUs of a first predetermined RU bandwidth, and
wherein a second portion of the candidate RU allocation indexes are mapped in accordance with a second division of the channel resources into a second group of RUs of a second predetermined RU bandwidth.

2. The apparatus according to claim 1, wherein:
the STA is a first STA,
the TF is configurable to be a uni-cast TF dedicated for the uplink OFDMA data transmission by the first STA, and
the TF is further configurable to be a multi-cast TF to be transmitted to a group of STAs that includes the first STA, wherein the multi-cast TF includes one or more other RU allocation indexes for one or more other uplink OFDMA data transmissions by the group of STAs.

3. The apparatus according to claim 1, wherein:
a bandwidth of the channel resources is configurable to be one of a group of candidate channel resource bandwidths, and
for different candidate channel resource bandwidths, non-overlapping portions of the RU allocation indexes are mapped in accordance with different divisions of the channel resources into RUs of different predetermined RU bandwidths.

4. The apparatus according to claim 3, wherein:
the group of candidate channel resource bandwidths includes 20, 40, 80 and 160 MHz, and
the different predetermined RU bandwidths are in a group that includes 2.03125, 4.0625, 8.28125, and 18.90625 MHz.

5. The apparatus according to claim 1, wherein:
the STA is a first STA, the RU is a first RU, and the RU allocation index is a first RU allocation index,
the processing circuitry is further configured to encode, for transmission to a second STA, a downlink data packet that includes a high efficiency (HE) header that includes a second RU allocation index of the group of candidate RU allocation indexes,
wherein the second RU allocation index indicates a second RU of the channel resources to be used for an uplink OFDMA transmission, by the second STA, of a block acknowledgement (BA) message for the downlink data packet.

6. The apparatus according to claim 1, wherein:
the TF further includes a spatial stream (SS) allocation block that indicates a group of one or more SSs of the STA that are to be used for the uplink OFDMA data transmission in accordance with a multiple user multiple input multiple output (MU-MIMO) arrangement,
wherein the group of SSs to be used are in a group of candidate SSs of the STA that are mapped to transmission paths of the STA.

7. The apparatus according to claim 6, wherein:
the SS allocation block includes an SS number and a starting SS, and
the indicated group of SSs includes the candidate SSs that are mapped to a group of SS indexes, and
the group of SS indexes is a consecutive group of size SS number that starts with the starting SS.

8. The apparatus according to claim 7, wherein:
the SS number is indicated by three bits and ranges between one and eight, and
the starting SS is indicated by three bits and ranges between one and eight.

9. The apparatus according to claim 1, wherein:
the indexes of the first portion are mapped to the first group of RUs in accordance with a first predetermined mapping, and
the indexes of the second portion are mapped to the second group of RUs in accordance with a second predetermined mapping.

10. The apparatus according to claim 1, wherein:
the RUs in the first group are non-overlapping in frequency,
the RUs in the second group are non-overlapping in frequency,
the RUs in the first group include a first number of sub-carriers, and
the RUs in the second group include a second number of sub-carriers.

11. The apparatus according to claim 1, wherein the group of candidate RU allocation indexes includes at least one additional index mapped to an RU of a third predetermined RU bandwidth.

12. The apparatus according to claim 1, wherein:
the first predetermined RU bandwidth is 2.03125 MHz,
the first group of RUs includes nine RUs, each comprising 26 non-overlapping sub-carriers,
the second predetermined bandwidth is 4.0625 MHz,
the second group of RUs includes four RUs, each comprising 52 non-overlapping sub-carriers,
a third portion of the candidate RU allocation indexes are mapped to a third group of one or more RUs of a third predetermined bandwidth of 8.28125 MHz,
the third group of RUs includes two RUs, each comprising 106 non-overlapping sub-carriers, and
a fourth portion of the candidate RU allocation indexes are mapped to a fourth group of one RU of a fourth predetermined bandwidth of 18.90625 MHz,
the fourth group of one RU includes an RU comprising 242 non-overlapping sub-carriers, and
the first, second, third and fourth portions of the candidate RU allocation indexes are further allocated for a 20 MHz bandwidth of the channel resources.

13. The apparatus according to claim 12, wherein:
the bandwidth of the channel resources is configurable to one of a candidate group of channel resource bandwidths that includes 20, 40, 80 and 160 MHz,
the first, second, third and fourth portions of the candidate RU allocation indexes are non-overlapping, and
additional non-overlapping portions of the RU allocation indexes are mapped for each of the candidate channel resource bandwidths in accordance with different divisions of the channel resources into RUs of predetermined RU bandwidths.

14. The apparatus according to claim 1, wherein the processing circuitry includes a baseband processor to encode the TF and to decode the OFDMA signal.

15. The apparatus according to claim 1, wherein the AP is arranged to operate in accordance with a wireless local area network (WLAN) protocol.

16. The apparatus according to claim 1, wherein the apparatus further includes a transceiver to transmit the TF and to receive the OFDMA signal.

17. A non-transitory computer-readable storage medium that stores instructions for execution by one or more processors to perform operations for communication by an access point (AP), the operations to configure the one or more processors to:
encode, for transmission, a trigger frame (TF) that includes a spatial stream (SS) allocation block that includes an SS number and a starting SS, the SS allocation block to indicate a group of one or more SSs of a station (STA) that are to be used for an uplink orthogonal frequency division multiple access (OFDMA) data transmission by the STA; and
decode, in accordance with the indicated group of SSs, one or more data streams of an OFDMA signal received from the STA,
wherein the indicated group of SSs are in a group of candidate SSs of the STA that are mapped to transmission paths of the STA,
the indicated group of SSs includes the candidate SSs that are mapped to a group of SS indexes, and
the group of SS indexes is a consecutive group of size SS number that starts with the starting SS.

18. The non-transitory computer-readable storage medium according to claim 17, wherein:
the SS number is indicated by three bits and ranges between one and eight, and
the starting SS is indicated by three bits and ranges between one and eight.

19. The non-transitory computer-readable storage medium according to claim 17, wherein:
the STA is a first STA,
the TF is a multi-cast TF to be transmitted to a group of STAs that includes the first STA,
the TF includes one or more other SS allocation indexes for one or more other uplink OFDMA data transmissions by the group of STAs.

20. The non-transitory computer-readable storage medium according to claim 17, wherein the TF is a uni-cast TF encoded for transmission to the STA.

21. The non-transitory computer-readable storage medium according to claim 17, the operations to further configure the one or more processors to:
encode, for transmission, a resource unit (RU) allocation index that indicates an RU of channel resources to be used for the uplink OFDMA data transmission by the STA,
wherein the OFDMA signal is further received from the STA in the indicated RU.

22. The non-transitory computer-readable storage medium according to claim 21, wherein:
the RU allocation index is one of a group of candidate RU allocation indexes,
a first portion of the candidate RU allocation indexes are mapped in accordance with a first division of the channel resources into a first group of RUs of a first predetermined RU bandwidth, and
a second portion of the candidate RU allocation indexes are mapped in accordance with a second division of the channel resources into a second group of RUs of a second predetermined RU bandwidth.

23. The non-transitory computer-readable storage medium according to claim 21, wherein:
the RU allocation index and the SS allocation block are encoded jointly to a combined RU/SS index, and
for at least one combination of sizes of the group of candidate RU allocation indexes and group of candidate SSs, a number of bits used for the combined RU/SS index is less than a sum of a number of bits used for the RU allocation index and a number of bits used for the SS allocation block.

24. The non-transitory computer-readable storage medium according to claim 17, wherein the AP is arranged to operate in accordance with a wireless local area network (WLAN) protocol.

25. A method of communication at an access point (AP), comprising:
encoding, for transmission to a station (STA), a downlink data packet that includes a high efficiency (HE) header; and
decoding a block acknowledgement (BA) message from the STA that includes an acknowledgement indicator for the downlink data packet,
wherein the HE header includes a resource unit (RU) allocation index that indicates an RU of channel resources to be used for an uplink orthogonal frequency division multiple access (OFDMA) transmission of the BA message by the STA,
wherein the RU allocation index is one of a group of candidate RU allocation indexes,
wherein a first portion of the candidate RU allocation indexes are mapped in accordance with a first division of the channel resources into a first group of RUs of a first predetermined RU bandwidth, and
wherein a second portion of the candidate RU allocation indexes are mapped in accordance with a second division of the channel resources into a second group of RUs of a second predetermined RU bandwidth.

26. The method according to claim 25, wherein:
the first predetermined RU bandwidth is 2.03125 MHz,
the first group of RUs includes nine RUs, each comprising 26 non-overlapping sub-carriers,
the second predetermined bandwidth is 4.0625 MHz,
the second group of RUs includes four RUs, each comprising 52 non-overlapping sub-carriers,
a third portion of the candidate RU allocation indexes are mapped to a third group of one or more RUs of a third predetermined bandwidth of 8.28125 MHz,
the third group of RUs includes two RUs, each comprising 106 non-overlapping sub-carriers, and
a fourth portion of the candidate RU allocation indexes are mapped to a fourth group of one RU of a fourth predetermined bandwidth of 18.90625 MHz,
the fourth group of RUs includes an RU comprising 242 non-overlapping sub-carriers, and
the first, second, third and fourth portions of the candidate RU allocation indexes are further allocated for a 20 MHz bandwidth of the channel resources.

27. The method according to claim 26, wherein:
the bandwidth of the channel resources is configurable to one of a candidate group of channel resource bandwidths that includes 20, 40, 80 and 160 MHz,
the first, second, third and fourth portions of the candidate RU allocation indexes are non-overlapping,
additional non-overlapping portions of the RU allocation indexes are mapped in accordance with different divisions into RUs for each of the channel resource bandwidths of 40, 80 and 160 MHz, and
the divisions into RUs for the channel resource bandwidths of 40, 80 and 160 MHz include divisions into RUs of predetermined RU bandwidths in a group that includes 2.03125, 4.0625, 8.28125, and 18.90625 MHz.

28. An apparatus for a station (STA), the apparatus comprising: memory; and processing circuitry configured to:
decode a downlink message from an access point (AP), wherein the downlink message includes a resource unit (RU) allocation index that indicates an RU of channel resources to be used for an uplink orthogonal frequency division multiple access (OFDMA) transmission by the STA, wherein the downlink message further includes a spatial stream (SS) allocation block that indicates a group of one or more SSs of the STA to be used for the uplink OFDMA transmission; and
encode an uplink message to be transmitted to the AP in accordance with the indicated RU and the indicated group of SSs,
wherein the RU allocation index is one of a group of candidate RU allocation indexes mapped to RUs of variable RU bandwidths,
wherein the channel resources of the RUs of a first RU bandwidth substantially overlap the channel resources of the RUs of a second RU bandwidth,
wherein the group of one or more SSs to be used are in a group of candidate SSs of the STA that are mapped to transmission paths of the STA.

29. The apparatus according to claim 28, wherein:
the RU allocation index and the SS allocation block are included in an information block dedicated to the STA,
the uplink OFDMA transmission is in a group that includes an uplink data transmission and an uplink block acknowledgement (BA) transmission,
when the uplink OFDMA transmission is an uplink data transmission, the information block is included in a trigger frame (TF) that indicates that the STA is to perform the uplink data transmission, and
when the uplink OFDMA transmission is an uplink BA transmission, the information block is included in a high efficiency (HE) header of a downlink data packet that is to be acknowledged by the STA in the uplink BA transmission.

30. The apparatus according to claim 28, wherein the processing circuitry includes a baseband processor to decode the downlink message and to encode the uplink message.

31. The apparatus according to claim 28, wherein the STA is arranged to operate in accordance with a wireless local area network (WLAN) protocol.

32. The apparatus according to claim 28, wherein the apparatus further includes a transceiver to receive the downlink message and to transmit the uplink message.
